(19) United States
(12) Patent Application Publication
(10) Pub. No.: US 2009/0147845 A1
(43) Pub. Date: Jun. 11, 2009

(54) IMAGE CODING METHOD AND APPARATUS

(75) Inventors: Atsushi MATSUMURA, Yokohama-shi (JP); Shinichiro KOTO, Kokubunji-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/329,429

(22) Filed: Dec. 5, 2008

(30) Foreign Application Priority Data
Dec. 7, 2007 (JP) 2007-317641

(51) Int. Cl. H04N 7/26

(52) U.S. Cl. 375/240.03; 375/E07.139; 375/E07.104

(57) ABSTRACT

An image coding method includes setting an input parameter indicating a coding control scheme and a color conversion scheme, the coding control scheme including at least one of an adaptive quantization scheme, a coding mode decision scheme and a motion detection scheme, and the color conversion scheme indicating a color conversion based on a variation of a level of a coding parameter changing based on the coding control scheme, analyzing an input image based on the coding control scheme to compute the coding parameter, processing the input image by color conversion based on the color conversion scheme and the coding parameter, selecting one of a preview mode and a non-preview mode based on a user instruction, and coding the input image in the non-preview mode and coding a processed image in the preview mode based on the coding control scheme of the input parameter and the coding parameter.

### CROSS-REFERENCE TO RELATED APPLICATIONS

This application is based upon and claims the benefit of priority from prior Japanese Patent Application No. 2007-317641, filed Dec. 7, 2007, the entire contents of which are incorporated herein by reference.

### BACKGROUND OF THE INVENTION

1. Field of the Invention

The present invention relates to an image coding method and apparatus for moving image or still image. More specifically, the present invention relates to a technique whereby the information held only on a coding side can be easily confirmed at the time of decoding.

2. Description of the Related Art

Generally, an authoring work for DVD (digital versatile disk) or a next-generation DVD (especially, the cell video disk) is carried out by repeating adjustment of a coding parameter of an image coding apparatus for each scene to improve the image to maximum quality. In the process, in order to confirm the effect of adjustment of the coding parameter, the compressed moving image data is reproduced by an image decoding unit and the image quality change due to adjustment of the coding parameter is visually confirmed. To confirm image quality change only visually, however, requires a large labor and abundant experiences.

The effect of adjustment of the coding parameter can be more easily confirmed by use of an image decoding apparatus (see “Product Manual (Nikon System, H.264 Analysis Tool”, for example) for decoding the additional information contained in the compressed moving image data and overlaying the decoded additional information on the display screen of the image. Examples of the additional information contained in the moving image data and overlaid include the motion vector, the quantization vector, the coding mode and the generated code amount.

Generally, in an image coding apparatus, a bit rate is controlled while at the same time controlling a quantization parameter for adaptive quantization. The adaptive quantization is carried out based on the activity of an input image. In the process, assuming that the quantization parameter is changed in magnitude by adjusting the coding parameter to change the intensity of the adaptive quantization, for example, this change is superposed with the change in the quantization parameter due to the bit rate control. Therefore, at the image decoding, the user cannot confirm the effect of the adaptive quantization based on activity enough according to the quantization parameter overlaid on display screen.

In the image coding apparatus, the adaptive quantization may be carried out by detecting the face area of the input image and controlling the quantization parameter downward in the face area. In the adaptive quantization based on activity, on the other hand, the quantization parameter may be controlled upward by the effect of the parts having a fine texture such as eyes, nose or the mouth in the face area. In the face area, therefore, the changes in the quantization parameters of the adaptive quantization based on activity and the adaptive quantization based on the face area detection offset each other. By simple observation of the quantization parameter overlaid on the display screen of a reproduced image, the user cannot confirm whether each control operation of the image coding apparatus is correctly performed or not at the time of decoding the image.

### BRIEF SUMMARY OF THE INVENTION

According to one aspect of the present invention, there is provided an image coding method comprising: setting an input parameter indicating a coding control scheme and a color conversion scheme, the coding control scheme including at least one of an adaptive quantization scheme, a coding mode decision scheme and a motion detection scheme, and the color conversion scheme indicating a color conversion based on a variation of a level of a coding parameter changing in accordance with the coding control scheme; analyzing an input image in accordance with the coding control scheme to compute the coding parameter; processing the input image by color conversion in accordance with the color conversion scheme and the coding parameter to generate a processed image; selecting one of a preview mode and a non-preview mode in accordance with a user instruction; and coding the input image in a non-preview mode and coding the processed image in a preview mode in accordance with the coding control scheme of the input parameter and the coding parameter.

### BRIEF DESCRIPTION OF THE SEVERAL VIEWS OF THE DRAWING

FIG. 1 is a block diagram showing the image coding apparatus according to an embodiment;

FIG. 2 is a block diagram showing a reproduction system including an image decoding apparatus corresponding to the image coding apparatus shown in FIG. 1;

FIG. 3 is a flowchart showing the processing steps of the image coding apparatus shown in FIG. 1;

FIG. 4 is a diagram showing an example of the input image;

FIG. 5 is a diagram showing an example of the input image after being processed according to the embodiment; and

FIG. 6 is a diagram showing another example of the input image after being processed according to the embodiment.

### DETAILED DESCRIPTION OF THE INVENTION

Embodiments of the invention will be explained below with reference to the drawings.

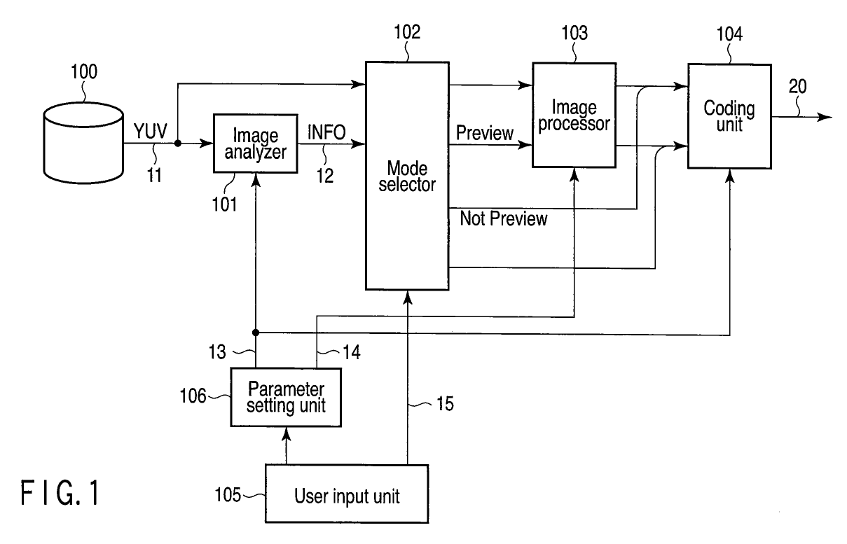

As shown in FIG. 1, the image coding apparatus according to an embodiment of the invention encodes an input image 11 and outputs a coded data (also called a coded bit stream) 20. The image coding apparatus includes an image analysis unit 101, a mode select unit 102 for selecting a preview mode/non-preview mode, an image processing unit 103, a coding unit 104, a user input unit 105 and a parameter setting unit 106. The input image 11 is the digital image data read from an image storage unit 100 like a hard disk drive. The image coding apparatus shown in FIG. 1 is capable of selecting the preview mode/non-preview mode using the select unit 102. In the case where the user (the operator doing the authoring work) selects the preview mode through the user input unit 105, for example, the input image 11 is coded by the coding unit 104 through the image processing unit 103. In the case where the non-preview mode is selected, on the other hand, the input image 11 is coded directly by the coding unit 104 without passing through the image processing unit 103.

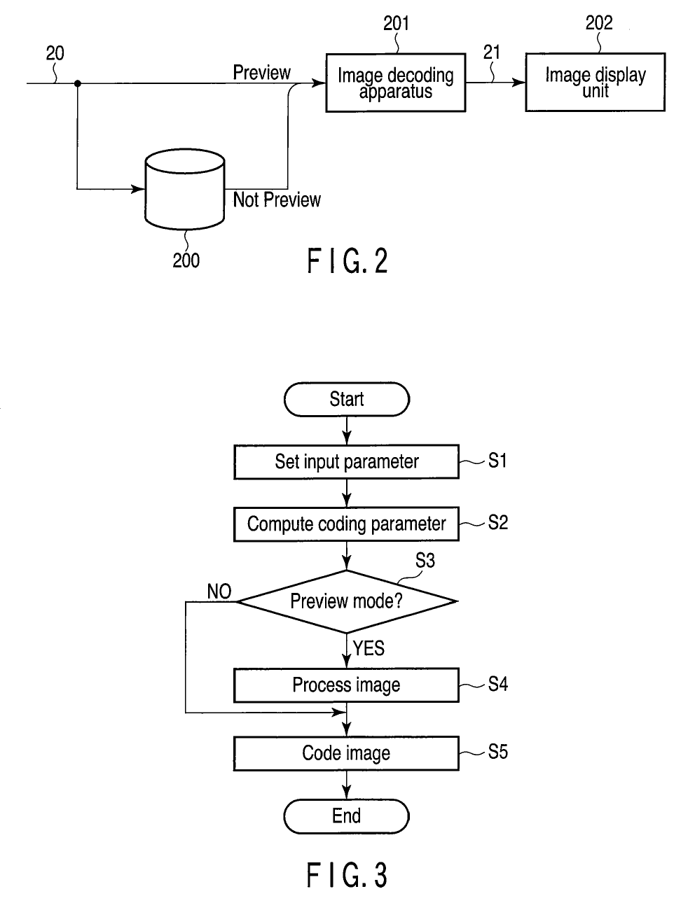

As shown in FIG. 2, the coded data 20 (the coded bit stream) obtained by the image coding apparatus is stored in a coded data storage unit 200 such as a hard disk drive. The coded data stored in the coded data storage unit 200 is decoded by an image decoding apparatus 201 whenever required, and displayed on an image display unit 202. In preview mode, the coded data may be decoded by the image decoding apparatus 201 without the intermediary of the coded data storage unit 200 and displayed on the image display unit 202.

Next, each unit of the image coding apparatus shown in FIG. 1 will be described.

The image analysis unit 101 analyzes the input image 11 in accordance with coding control scheme designation information 13 indicating the coding control scheme designated by the user, of all the input parameters set for the input image 11 by the input parameter setting unit 106, and computes and outputs a coding parameter 12. The coding control scheme and the image analysis scheme will be described later, in detail.

The image processing unit 103, in accordance with the coding parameter 12 and a color conversion scheme designation information 14 included in the input parameter set by the input parameter setting unit 106 and indicating the color conversion scheme designated by the user, executes the processes including the color conversion on the input image 11 and generates a processed image. The mode select unit 102 selects the preview mode or non-preview mode in response to the user instruction. The color conversion scheme will be described later, in detail.

The image coding apparatus can select the preview mode or the non-preview mode through the mode select unit 102. In the case where the input image 11 is coded in preview mode, the input image 11 and the coding parameter 12 outputted through the mode select unit 102 from the image analysis unit 101 are input to the image processing unit 103, so that the input image 11 is processed as described above. The processed image generated by the image processing unit 103 is input to the coding unit 104, and coded in accordance with the coding parameter 12 and the coding control scheme designation information 13.

In the case where the input image 11 is coded in non-preview mode, on the other hand, the input image 11 and the coding parameter 12 outputted from the image analysis unit 102 are directly input to the coding unit 104 bypassing the image processing unit 103. Then, the input image 11 is coded in accordance with the coding parameter 12 and the coding control scheme designation information 13.

According to this embodiment, the input image 11 is described as a moving image. Nevertheless, the input image 11 may alternatively be a still image. In the case where the input image 11 is a moving image, the coding scheme of the coding unit 104 may be any arbitrary one of the various publicly known moving image compression-coding schemes such as MPEG-1, MPEG-2, MPEG-4, H.264 and VC-1. According this embodiment, the coding unit 104 is assumed to employ H.264. In the case where the input image 11 is a still image, on the other hand, the coding unit 104 may employ any arbitrary one of the various well-known still image compression-coding schemes such as JPEG, JPEG2000 and H.264 Intra.

The description that follows assumes that the analysis in the image analysis unit 101 and the computation of the coding parameter are carried out in units of a macro block. Nevertheless, the process of the image analysis unit 101 may be executed in units of plural macro blocks.

Next, the operation of the image coding apparatus according to this embodiment will be described with reference to the flowchart of FIG. 3.

First, in accordance with the user command given through the user input unit 105, the input parameter setting unit 106 sets the coding control scheme and the color conversion scheme (step S1). The coding control scheme is a scheme of controlling the coding operation of the coding unit 104, and indicates at least one of the adaptive quantization scheme, the coding mode decision scheme and the motion detection scheme. The color conversion scheme indicates a scheme of converting the color of the input image 11 such as converting only the chrominance component of the input image 11. Incidentally, plural coding control schemes may be set, each having a corresponding color conversion scheme. For example, in the presence of plural coding control schemes, only one color conversion scheme shared by all the coding control schemes or the color conversion schemes smaller in number than the coding control schemes may be used. Also, each coding control scheme may correspond to a different color conversion scheme.

Next, the input image 11 is analyzed based on the coding control scheme set by the input parameter setting unit 106 in the image analysis unit 101. Specifically, the image analysis unit 101 analyzes the features of the input image 11 designated in advance by the user, such as the activity, color composition or the interframe difference, and in accordance with the analysis result, computes the coding parameter 12 (step S2). In the case where the input image 11 is a still image, however, the interframe difference is not contained in the features analyzed by the image analysis unit 101.

Next the user input unit 105 checks whether the preview mode or the non-preview mode is selected (step S3), and in accordance with the result thereof, a mode select signal 15 is sent to the mode select unit 102.

In the case where the preview mode is selected, the input image 11 and the coding parameter 12 from the image analysis unit 102 are input to the image processing unit 103 by the mode select unit 102, so that the input image 11 is processed in accordance with the color conversion scheme designated by the user and indicated by the coding scheme designation information 14 from the parameter setting unit 106 (step S4). Specifically, based on the level variation of the coding parameter changing in accordance with the coding control scheme, the color conversion of the input image 11 is carried out. Next, the processed image generated in step S4 is coded by the coding unit 104 (step S5).

In the preview mode, the coded data 20 outputted from the coding unit 104 is decoded by the image decoding apparatus 201, and a reproduced image 21 is displayed (previewed) on the image display unit 202. At the same time, the user can confirm the effect of adaptive quantization from the color conversion state in the image displayed on the image display unit 202. This point will be described below with reference to specific examples.

In the case where the non-preview mode is selected, on the other hand, the input image 11 and the coding parameter 12 outputted from the image analysis unit 102 are caused by the mode select unit 102 to bypass the image processing unit 103, and are directly input to the coding unit 104 thereby to code the input image 11 (step S5). In this non-preview mode, the coded data 20 outputted from the coding unit 104 is usually stored in the coded data storage unit 200, and by being appropriately read, decoded by the image decoding apparatus 201.

The coding unit 104 continues the coding process in the presence of the input image 11, and ends the coding process in the absence of the input image 11. In the case where the coding process is continued, the control returns to step S2 unless the user changes the input parameter. In the case where the input parameter is changed by the user, on the other hand, the control is returned to step S1 in which the input parameter, i.e. the coding control scheme and the color conversion scheme are set again.

Next, the coding control scheme and the color conversion scheme will be described in detail.

(1) <Coding Control Scheme>

Examples of the coding control scheme, one of the input parameters set by the parameter setting unit 106 include, for example, the following schemes: (1) the adaptive quantization scheme; (2) the coding mode decision scheme; and (3) the motion detection scheme. Each scheme will be specifically described below.

(1-1) Adaptive Quantization Scheme

The adaptive quantization uses at least one of the scheme of controlling the quantization parameter based on the activity, the scheme of controlling the quantization parameter based on the face likelihood, the scheme of controlling the quantization parameter based on similarity between a designated specific color and a representative color of each designated area, and the scheme of controlling the quantization parameter based on the edge likelihood.

(1-1-1) Quantization Parameter Control Scheme Based on Activity

Generally, the image quality deterioration in an area high in image activity is less conspicuous, and vice versa. Therefore, the subjective image quality may be improved by controlling the quantization parameter in accordance with the image activity.

In view of this, the coding control scheme (adaptive quantization scheme) is set in such a manner that a large activity leads to a large quantization parameter (for example, a large quantization parameter offset (plus)) and a small activity leads to a small quantization parameter (for example, a small quantization parameter offset (minus)).

(1-1-2) Quantization Parameter Control Scheme Based on Face Likelihood

The image deterioration of the face of a person which is generally a most closely watched part is more liable to be recognized, if displayed on the screen, than any other areas. Therefore, the subjective image quality may be improved by controlling the quantization parameter for the part (face area) determined as a face in the image by the face detect operation.

In view of this, the coding control scheme (adaptive quantization scheme) is set in such a manner that the quantization parameter offset is small (minus) in the case where the face detection result shows a high probability of being a face (face likelihood), and large (plus) in the case where the probability of being a face is low.

(1-1-3) Quantization Parameter Control Scheme Based on Similarity Between a Designated Specific Color and a Representative Color of Each Designated Area

In addition to the face of a person, the neck, the hand or the body may be also a closely watched area. Therefore, the subjective image quality may be improved by detecting the skin color and controlling the quantization parameter for the particular part. Also, the coding distortion is liable to be conspicuous in a dark part or a vivid (high in saturation) red part, and therefore, the subjective image quality may be improved by detecting the color area (such as Macroblock) and controlling the quantization parameter for the area (such as Macroblock) of a specified color.

In view of this, the coding control scheme (adaptive quantization scheme) is set in such a manner that the quantization parameter offset is small (minus) for the area of a representative color high in similarity (color similarity) to the specified color designated in advance by the user such as the skin color, the dark part or the vivid red in the input image 11, while the quantization parameter offset is large (plus) for the area of a representative color low in similarity to the specified color.

(1-1-4) Quantization Parameter Control Scheme Based on Edge Likelihood

At a sharp edge of a character or the like in the image, the subjective image quality may be deteriorated by the ringing for lack of the high frequency component due to the coding. Therefore, the subjective image quality may be improved by controlling the quantization parameter of the part determined as an edge by the edge detect operation.

Thus, the coding control scheme (adaptive quantization scheme) is set in such a manner that the quantization parameter offset is small (minus) for the edge area (area large in edge likelihood) and the quantization parameter offset is large (plus) for an area other than the edge area (area small in edge likelihood).

Incidentally, the quantization parameter offset, though controlled upward or downward in accordance with the face likelihood, the detection result of a specified color or the edge likelihood in the adaptive quantization according to the coding control scheme described above, may alternatively be controlled in one direction. For example, the quantization parameter offset may be controlled only downward in the skin color area but not in the other areas. This is caused by the fact that, in the actual coding process, the quantization parameter is controlled by a bit rate. By this, the reduction of the quantization parameter for a given area is accompanied by the relative increase of the quantization parameter for the other areas.

(1-2) Coding Mode Decision Scheme

(1-2-1) Cost Function Control Scheme Based on Activity

Generally, the coding mode is selectively decided to minimize the cost indicated in Equation (1) below.

Cost=Distortion+λ×Rate (1)

where λ is Lagrange's undetermined multiplier and Rate the generated code amount.

The factor λ for striking the balance between the distortion and the generated code amount normally remains constant in the screen. The image quality may be improved, however, by changing the factor λ for attaining the cost balance in the coding mode decision in accordance with the image activity. Thus, the coding control scheme (coding mode decision scheme) is set in such a manner that an increased activity leads to a larger coefficient α (λ=α×λ base) for adjusting λ according to the λ base, and vice versa.

(1-3) Motion Detection Scheme

(1-3-1) Cost Function Control Scheme Based on Activity

Generally, in the motion detection scheme, substantially similarly to the coding mode decision scheme described above, the motion vector minimizing the cost described above is searched for at the time of determining the motion vector. Generally, however, “Rate” indicates only the information of the motion vector. By changing the value λ for achieving the cost balance of the motion vector in accordance with the image activity, the image quality may be improved, and therefore, the coding control scheme (motion vector detection scheme) is set in such a manner that a larger activity leads to a larger β as a coefficient (λ=β×λ base) for adjusting λ, and vice versa.

(1-3-2) Control Scheme Based on Motion Detection Algorithm

Various schemes are available for the motion detection algorithm. The full search, the hierarchical search, the diamond search and the hexagon search are some examples. The hierarchical search, the diamond search and the hexagon search, as compared with the full search, are accompanied by a smaller amount of the arithmetic operation and are capable of high-speed motion detection due to the early termination and the thinning process. On the other hand, these high-speed motion vector detection algorithms are liable to result in a local solution.

Specifically, as long as the difference between the current image to be coded and the already coded reference image obtained by local decoding is small, a small motion is predicted, and therefore, the high-speed motion vector detection algorithms described above are not inferior to the full search. In the case where the difference between the current image and the reference image is large, on the other hand, a large motion is predicted, and therefore, the difference is liable to be large between the high-speed motion vector detection algorithm and the full search. Thus, the coding control scheme (motion vector detection scheme) is set in such a manner that a large difference between the current image and the reference image leads to the full search while a small difference between the current image and reference image leads to the hierarchical search, the diamond search or the hexagon search.

(2) <Color Conversion Scheme>

(2-1) Chrominance Conversion

The image processing unit 103 performs the color conversion of the input image 11 based on the variation of the level of the coding parameter (the value of the quantization parameter, for example, in the case where the coding control scheme is the adaptive quantization) changing in accordance with the coding control scheme. If the color conversion is performed to such an extent as to change the luminance signal, the information of the input image 11 is adversely affected and the original shape of the object becomes unclear.

By converting only the chrominance signal without changing the luminance signal of the input image 11, the color change corresponding to the level change of the coding parameter can be confirmed while leaving the information such as the shape of the input image 11. According to this embodiment employing the coding scheme H.264 for the coding unit 104, the input image 11 is configured of the YUV (YCbCr) signal, and therefore, only the chrominance signal, i.e. only the UV (CbCr) is changed for color conversion. Thus, the color conversion scheme is set in such a manner that in the case where the quantization parameter offset value is large, for example, the value V (Cr) is increased to increase the darkness of red, while in the case where the quantization parameter offset value is small, the U (Cb) value is increased to increase the darkness of blue.

(2-2) Conversion of User Designation

The color conversion scheme is set for direct conversion of the designated color in such a manner that in the case where the quantization parameter offset value is −10, for example, Y equals the current signal, U (Cb) equal 240 and V (Cr) equals 128. This designation of the color conversion scheme by the user is effective especially in employing the coding control scheme having the effect on the same coding parameter.

In the case where both the adaptive quantization by activity and the adaptive quantization by face likelihood are used at the same time as the color conversion in the coding control scheme, for example, the color conversion scheme is so set that the quantization parameter offset due to the adaptive quantization by activity changes to red and the quantization parameter offset due to the adaptive quantization by face likelihood changes to blue. In this way, the mixture color of red and blue components is generated and therefore the effect thereof can be determined in the area where the adaptive quantization by both activity and face likelihood is effective.

(2-3) Other Color Conversions

For example, the degree of fade may be changed by changing the magnitude of the coding parameter or the contrast may be changed in magnitude. Also, the color conversion may be carried out to reverse (Y=240−Y base) the luminance signal of the input image 11. Many other various color conversion schemes are available, of which a scheme is preferably determined in which the level change of the coding parameter such as the quantization parameter can be easily confirmed visually.

(3) <Image Analysis Scheme>

Next, the image analysis scheme by the image analysis unit 101 will be specifically described. The image analysis scheme is assumed to further include the coding parameter computation scheme. The image analysis scheme is determined in accordance with the coding control scheme. The image analysis scheme corresponding to each of the (1-1) the adaptive quantization scheme, (1-2) the coding mode decision scheme, and (1-3) the motion vector detection scheme as the coding control scheme will be described below.

(3-1) <Image Analysis Scheme Corresponding to Adaptive Quantization Scheme>

(3-1-1) In the Case Where the Adaptive Quantization Scheme is (1-1-1) “Quantization Parameter Control Scheme Based on Activity”

In the case where the coding control scheme set by the parameter setting unit 106 is the quantization parameter control scheme based on the activity, of all the adaptive quantization schemes, the image analysis unit 101 analyzes (computes) the activity of the input image 11. In controlling the coding parameter, the macro block unit is generally the minimum grain size and therefore the activity is computed in units of macro block.

The variance or the standard deviation, for example, of the input image 11 is used as the activity. From the activity for each macro block thus computed, the quantization parameter offset is computed, for example, using Equation (2) below.

$$QP\_OFFSET = ( \frac{MB\_act - minMB\_act}{maxMB\_act - minMB\_act} - \frac{1}{2} ) \times Scale \qquad ( 2 )$$

where maxMB_act is the maximum macro block activity in one or plural screens, minMB_act the minimum macro block activity in one or plural screens, MB_act the activity of the macro block involved, and Scale the control range of the quantization parameter designated by the user.

(3-1-2) In the Case Where the Adaptive Quantization Scheme is (1-1-2) “Quantization Parameter Control Scheme Based on Face Likelihood”

In the case where the coding control scheme set by the parameter setting unit 106 is the quantization parameter control scheme based on the face likelihood, of all the adaptive quantization schemes, the image analysis unit 101 computes the face likelihood by detecting the face area from the input image 11. Various face detection logics are available. In the case of template matching using the face data base, for example, the face can be detected in such a manner that the smaller the matching difference, the higher the face likelihood. This embodiment, however, is not dependent on the face detection logics but only needs to identify a face.

The grain size of the face likelihood obtained is varied with the grain size for template matching (for example, matching in units of pixel). Taking into consideration that the quantization parameter offset is finally controlled, however, the face likelihood is required to be integrated in units of macro block. The face likelihood, if computed with finer grain size than the macro block unit, can be averaged in the macro block, and if computed with rough grain size, on the other hand, can be computed in terms of area ratio.

To compute the quantization parameter offset from the likelihood in macro block units, the face likelihood may be used in place of activity. In the case where the face likelihood is not less than a predetermined threshold value, a scheme may alternatively be used simply to set the quantization parameter offset at a predetermined value.

(3-1-3) In the Case Where the Adaptive Quantization Scheme is (1-1-3) “Quantization Parameter Control Scheme Based on Color Similarity of a Specified Color”

In the case where the coding control scheme set by the parameter setting unit 106 is the quantization parameter control scheme based on the color similarity, of all the adaptive quantization schemes, the image analysis unit 101 computes the similarity (color similarity) to the specified color designated for the input image 11. In controlling the coding parameter, the color similarity is generally computed in macro block units since the macro block unit is the minimum grain size.

For this reason, the representative color in macro block unit is first computed. The representative color may be computed as the average value or the central value of the color in the macro block or the average value or the central value of the subsampled value. The color similarity in macro block unit is computed as a difference between the representative color and the designated specified color. In the case where YUV is designated as a specified color, for example, the sum of the differences of the absolute value of Y, U and V is computed. Also, in the case where the specified color is set to detect the dark part, for example, the weight of the Y difference may be increased while reducing the weight for U and V.

In computing the quantization parameter offset constituting the coding parameter from the color similarity in units of macro block computed in this way, the color similarity can be used in place of the activity described above. As an alternative, the quantization parameter offset may be simply set at a predetermined value in the case where the color similarity is not less than a predetermined threshold value.

Incidentally, a specified color, though designated from the YUV colorimetric system in this case, may alternatively be designated from the RGB colorimetric system or the HSV colorimetric system. In the case where a specified color is designated from the HSV colorimetric system, for example, the input image 11 (YUV signal), after being converted to the RGB signal, may be converted to the HSV signal to compute the similarity. Also, the designated color of the HSV colorimetric system, after being converted to RGB, may be converted to YUV to compute the similarity to the input image 11.

(3-1-4) In the Case Where the Adaptive Quantization Scheme is (1-1-4) “Quantization Parameter Control Scheme Based on Edge Likelihood”

In the case where the coding control scheme set by the parameter setting unit 106 is the quantization parameter control scheme based on the edge likelihood specifically, of all the adaptive quantization schemes, the edge area is detected from the input image 11 in the image analysis unit 101.

Various logics are available for edge detection. In the edge detection using the edge detection operator (Sobel operator or the like), for example, the edge detection is possible in such a manner that the steeper the edge, the larger the edge component value (edge likelihood). This embodiment, however, is not dependent on the edge detection logics but may employ a scheme capable of operation upon decision whether an edge is involved or not. The edge detection by the edge detection operator can be realized by a similar process to the template matching for the face detection described above and the quantization parameter offset can also be computed by a similar process.

(3-2) <Image Analysis Scheme Corresponding to Coding Mode Decision Scheme>

(3-2-1) In the Case Where the Cost Function is Controlled Based on Activity

In the case where the coding control scheme set by the parameter setting unit 106 is the cost function control scheme for the coding mode decision based specifically on activity, of all the coding mode decision schemes, the image analysis unit 101 computes the activity as described with reference to the adaptive quantization scheme. From the activity for each macro block thus computed, the coefficient a for adjusting λ is computed using Equation (3) below.

$$α = \frac{MB\_act - minMB\_act}{maxMB\_act - minMB\_act} \qquad ( 3 )$$

As an alternative, the coefficient α for adjusting λ may be set at a predetermined value simply in the case where the activity is not lower than a predetermined threshold value.

(3-3) <Image Analysis Scheme Corresponding to Motion Detection Scheme>

(3-3-1) Cost Function Control Based on Activity

In the case where the coding control scheme set by the parameter setting unit 106 is specifically the cost function control scheme based on activity, of all the motion detection schemes, the image analysis unit 101 executes the same process as (3-2-1) “Cost function control based on activity” of the image analysis scheme corresponding to the coding mode decision, and therefore, will not be repeated here.

(3-3-2) Control Based on Motion Detection Algorithm

In the case where the coding control scheme set by the parameter setting unit 106 is the motion detection algorithm select scheme specifically based on the interframe difference, of all the motion detection schemes, the image analysis unit 101 computes the interframe difference from the input image 11. In controlling the coding parameter, the interframe difference is computed also in macro block units due to the fact that the macro block is generally the unit of minimum grain size.

The interframe difference may be computed either by computing the difference between the screens at the same spatial coordinate or the minimum interframe difference from within a predetermined range of the image referred to. To select the motion detection algorithm from the interframe difference thus computed, the full search is selected, for example, in the case where the interframe difference is not less than a predetermined threshold value, while the diamond search is selected in the case where the interframe difference is not more than the predetermined threshold value.

Tables 1 to 7 show the correspondence between the coding control scheme described above and the color conversion scheme (only the chrominance conversion). Thus, the image processing unit 103 processes the input image 11 by conversion based on Tables 1 to 7, for example, in accordance with the coding parameter computed by the image analysis unit 101 and the color conversion scheme set by the parameter setting unit 106. Specifically, Tables 1 to 7 are held in a storage unit not shown, and the image processing unit 103 processes the input image 11 by referencing the tables.

Table 1 shows the relation between the quantization parameter offset and the chrominance conversion value (chrominance signal after conversion) for the activity change in the case of the adaptive quantization based on activity, i.e. in the case where the coding control scheme is (1-1-1) “Quantization parameter control scheme based on activity” described above. In the case where the color conversion scheme is designated by the user, a designated color (all the components of YUV or only UV) may be used in place of the magnitude of the color conversion value. Also, the control range of the quantization parameter offset, i.e. the scale of Equation (2) described above, though in 21 gradations from +10 to −10 in Table 1, may be set freely by the user. This is also true for Tables 2 to 7.

TABLE 1
Adaptive quantization based on activity

| | Quantization | Chrominance |
|---|---|---|
| Activity | parameter offset | conversion value |
| Minimum MB value | −10 | Cb = 240/Cr = 128 |
| . . . | | . . . |
| . . . | | . . . |
| . . . | | . . . |
| Frame average | 0 | Cb = 128/Cr = 128 |
| (intermediate) | | |
| . . . | | . . . |
| . . . | | . . . |
| . . . | | . . . |
| Maximum MB value | +10 | Cb = 128/Cr = 240 |

Table 2 shows the relation between the quantization parameter offset and the chrominance conversion value for the face likelihood change in the case of the adaptive quantization based on face likelihood, i.e. in the case where the coding control scheme is (1-1-2) “Quantization parameter control scheme based on face likelihood”.

TABLE 2
Adaptive quantization based on likelihood

| | Quantization | Chrominance |
|---|---|---|
| Likelihood | parameter offset | conversion value |
| 100 | −10 | Cb = 240/Cr = 128 |
| . . . | | . . . |
| . . . | | . . . |
| . . . | | . . . |
| 50 | 0 | Cb = 128/Cr = 128 |
| . . . | | . . . |
| . . . | | . . . |
| . . . | | . . . |
| 0 | +10 | Cb = 128/Cr = 240 |

Table 3 shows the relation between the quantization parameter offset and the chrominance conversion value for the color similarity (chrominance) change in the case of the adaptive quantization based on the detection of a specified color, i.e. in the case where the coding control scheme is (1-1-3) “Quantization parameter control scheme based on similarity of specified color”.

TABLE 3
Adaptive quantization based on
specified color detection

| Color similarity | Quantization | Chrominance |
|---|---|---|
| (difference) | parameter offset | conversion value |
| 0 | −10 | Cb = 240/Cr = 128 |
| . . . | | . . . |
| . . . | | . . . |
| . . . | | . . . |
| 50 | 0 | Cb = 128/Cr = 128 |
| . . . | | . . . |
| . . . | | . . . |
| . . . | | . . . |
| 100 | +10 | Cb = 128/Cr = 240 |

Table 4 shows the relation between the quantization parameter offset and the chrominance conversion value for the edge likelihood change in the case of the adaptive quantization based on the edge likelihood, i.e. in the case where the coding control scheme is (1-1-4) “Quantization parameter control scheme based on edge likelihood”.

TABLE 4
Adaptive quantization based on
edge likelihood

| | Quantization | Chrominance |
|---|---|---|
| Edge likelihood | parameter offset | conversion value |
| 100 | −10 | Cb = 240/Cr = 128 |
| . . . | | . . . |
| . . . | | . . . |
| . . . | | . . . |
| 50 | 0 | Cb = 128/Cr = 128 |
| . . . | | . . . |
| . . . | | . . . |
| . . . | | . . . |
| 0 | +10 | Cb = 128/Cr = 240 |

Table 5 shows the relation between the adjustment coefficient α of Lagrange's undetermined multiplier λ (i.e. the coefficient for adjusting λ with the λ base as a reference) and the chrominance conversion value for the activity change in the case where the coding control scheme is (1-2-1) “Cost function control scheme based on activity” in (1-2) “Coding mode decision scheme”.

TABLE 5
Cost function for coding mode decision
based on activity

| | Quantization | Chrominance |
|---|---|---|
| Edge likelihood | parameter offset | conversion value |
| 100 | 0 | Cb = 240/Cr = 128 |
| . . . | | . . . |
| . . . | | . . . |
| . . . | | . . . |
| 50 | 1.0 | Cb = 128/Cr = 128 |
| . . . | | . . . |
| . . . | | . . . |
| . . . | | . . . |
| 0 | 2.0 | Cb = 128/Cr = 240 |

Table 6 shows the relation between the adjustment coefficient α of λ and the chrominance conversion value for the activity change in the case where the coding control scheme is (1-3-1) “Cost function control scheme based on activity” in (1-3) “Motion detection scheme”.

TABLE 6
Cost function for motion detection
based on activity

| | Adjustment coefficient α of | Chrominance |
|---|---|---|
| Activity | undetermined multiplier λ | conversion value |
| 100 | 0 | Cb = 240/Cr = 128 |
| . . . | | . . . |
| . . . | | . . . |
| . . . | | . . . |
| 50 | 1.0 | Cb = 128/Cr = 128 |
| . . . | | . . . |
| . . . | | . . . |
| . . . | | . . . |
| 0 | 2.0 | Cb = 128/Cr = 240 |

Finally, Table 7 shows the relation between the motion detection algorithm of λ and the chrominance conversion value for the interframe difference change in the case where the coding control scheme is (1-3-2) “Control scheme based on motion detection algorithm” in (1-3) “Motion detection scheme”.

TABLE 7
Motion detection algorithm based on
interframe difference

| | | Chrominance |
|---|---|---|
| Interframe | Motion detection | conversion |
| difference | algorithm | value |
| Maximum MB | Full search | Cb = 240/Cr = 128 |
| value | | |
| . . . | | . . . |
| . . . | | . . . |
| . . . | | . . . |
| Frame | Hierarchical search | Cb = 128/Cr = 128 |
| average | | |
| . . . | | . . . |
| . . . | | . . . |
| . . . | | . . . |
| Minimum MB | Diamond search | Cb = 128/Cr = 240 |
| value | | |

The input image 11 is processed by color conversion by the image processing unit 103 in preview mode using the tables shown above, and the processed image is coded by the coding unit 104. The coded data is decoded by the image decoding apparatus 201 and displayed on the image display unit 202. Thus, the effect of adaptive quantization can be confirmed from the result of color conversion.

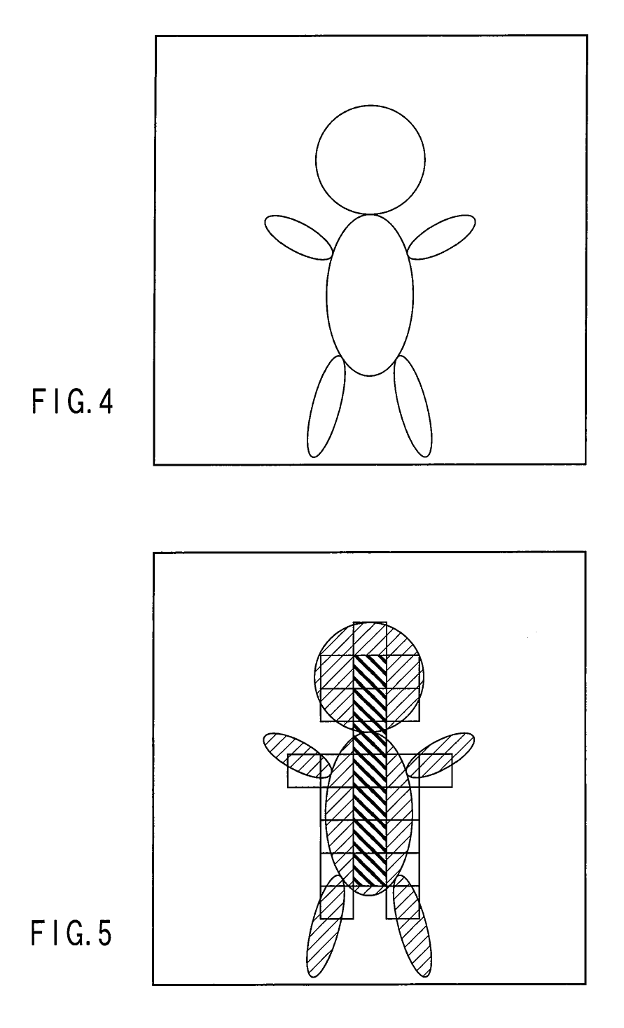

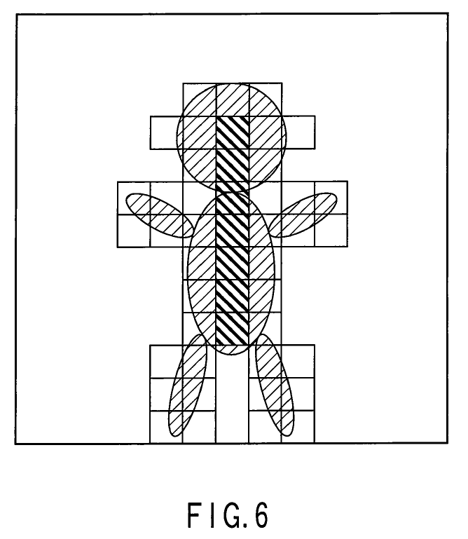

An example of the effects according to this embodiment will be described with reference to FIGS. 4 to 6. Assume that the input image 11 is that of a person as shown in FIG. 4, an adaptive quantization scheme based on a specified color or, especially, the skin color is set as a coding control scheme, and the macro block is painted as thick as the skin color as a color convention scheme. In this case, the processed image shown in FIG. 5 is obtained by the process executed by the image processing unit 103. Further, the processed image shown in FIG. 6 is obtained by increasing the intensity (the scale that can be increased by the adaptive quantization based on activity described above) set by the user.

The foregoing description concerns a case in which the input image 11 is a moving image. In the case where the input image 11 is a still image and the coding control scheme of the coding unit 104 is JPEG, for example, the adaptive quantization based on activity, edge likelihood or color similarity can be carried out in the same manner as in the moving image. In the case of a still image, however, the motion detection algorithm and the motion detection scheme are of course not applicable.

As described above, according to the embodiments of the invention, the input image is processed by color conversion corresponding to the coding parameter level (for example, the value of the quantization parameter in adaptive quantization) in preview mode. In this way, the information on the adaptive quantization, the coding mode decision scheme or the motion detection which is held only in the image coding apparatus can be easily confirmed by the image decoding apparatus.

Also, the effect of adaptive quantization can be easily confirmed from the display on the screen simply by decoding the coded data and reproducing the image by the image decoding apparatus, and therefore, a special system construction is not required and the cost is not increased.

Incidentally, the image coding apparatus according to the embodiments of the invention described above can be realized also by using a multipurpose computer as basic hardware. Specifically, the image analysis unit 101, the image processing unit 103 and the coding unit 104 can be realized, in particular, by causing the processor mounted on the computer system to execute the program. In the process, the image coding apparatus may be implemented by installing the program in the computer in advance, or by distributing the program stored in the storage medium such as a CD-ROM or through a network and installing the particular program in the computer system appropriately. Also, the image storage unit 100 and the coded data storage unit can be realized by appropriately using the storage medium such as a memory, a hard disk, a CD-R, a CD-RW, a DVD-RAM or a DVD-R built in the computer or installed onto the exterior of the computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image coding method comprising:
setting an input parameter indicating a coding control scheme and a color conversion scheme, the coding control scheme including at least one of an adaptive quantization scheme, a coding mode decision scheme and a motion detection scheme, and the color conversion scheme indicating a color conversion based on a variation of a level of a coding parameter changing in accordance with the coding control scheme;
analyzing an input image in accordance with the coding control scheme to compute the coding parameter;
processing the input image by color conversion in accordance with the color conversion scheme and the coding parameter to generate a processed image;
selecting one of a preview mode and a non-preview mode in accordance with a user instruction; and
coding the input image in the non-preview mode and coding the processed image in the preview mode in accordance with the coding control scheme and the coding parameter.

2. The method according to claim 1, wherein the color conversion scheme is to convert a chrominance signal of the input image in accordance with the level of the coding parameter.

3. The method according to claim 1, wherein the coding control scheme includes a scheme of controlling a magnitude of a quantization parameter for use in the adaptive quantization scheme based on a magnitude of an activity of the input image, and the analyzing includes a computation of the activity.

4. The method according to claim 1, wherein the coding control scheme includes a scheme of controlling a magnitude of a quantization parameter for use in the adaptive quantization scheme based on a face likelihood within the input image, and the analyzing includes a detection of a face area from the input image and a computation of the face likelihood.

5. The method according to claim 1, wherein the coding control scheme includes a scheme of controlling a magnitude of a quantization parameter for use in the adaptive quantization scheme based on a magnitude of an edge likelihood within the input image, and the analyzing includes a detection of an edge area from the input image and a computation of an edge likelihood.

6. The method according to claim 1, wherein the coding control scheme includes a scheme of controlling a magnitude of a quantization parameter for use in the adaptive quantization scheme based on a similarity between a designated specific color and a representative color of each designated area within the input image, and the analyzing includes a computation of the similarity.

7. The method according to claim 1, wherein the coding control scheme includes a scheme of controlling a cost function of a coding mode decision based on a magnitude of an activity of the input image, and the analyzing includes a computation of the activity.

8. The method according to claim 1, wherein the coding control scheme includes a scheme of controlling a cost function of a motion vector detection based on a magnitude of an activity in the input image, and the analyzing includes a computation of the activity.

9. The method according to claim 1, wherein the coding control scheme includes a scheme of selecting a motion detection algorithm based on a magnitude of an interframe difference of the input image, and the analyzing includes a computation of the interframe difference.

10. An image coding apparatus comprising:
a setting unit configured to set an input parameter indicating a coding control scheme and a color conversion scheme, the coding control scheme including at least one of an adaptive quantization scheme, a coding mode decision scheme and a motion detection scheme, and the color conversion scheme indicating a color conversion based on a variation of a level of a coding parameter changing in accordance with the coding control scheme;
an analysis unit configured to compute the coding parameter by analyzing the input image in accordance with the coding control scheme;
a processing unit configured to generate a processed image by subjecting the input image to a process including color conversion in accordance with the color conversion scheme and the coding parameter;
a select unit configured to select the preview mode or the non-preview mode; and
a coding unit configured to code the input image in the non-preview mode and the processed image in the preview mode in accordance with the coding control scheme of the input parameter and the coding parameter.

11. The apparatus according to claim 10, wherein the color conversion scheme includes a scheme of converting a chrominance signal of the input image in accordance with the level of the coding parameter.

12. The apparatus according to claim 10, wherein the coding control scheme includes a scheme of controlling a magnitude of a quantization parameter for use in the adaptive quantization scheme based on a magnitude of an activity of the input image, and the analysis unit is configured to compute the activity.

13. The apparatus according to claim 10, wherein the coding control scheme includes a scheme of controlling a magnitude of a quantization parameter for use in the adaptive quantization scheme based on a face likelihood within the input image, and the analysis unit is configured to detect a face area from the input image and compute the face likelihood.

14. The apparatus according to claim 10, wherein the coding control scheme includes a scheme of controlling a magnitude of a quantization parameter for use in the adaptive quantization scheme based on an edge likelihood within the input image, and the analysis unit is configured to detect an edge area from the input image and compute the edge likelihood.

15. The apparatus according to claim 10, wherein the coding control scheme includes a scheme of controlling a magnitude of a quantization parameter for use in the adaptive quantization scheme based on a similarity between a designated specific color and a representative color of each designated area in the input image, and the analysis unit is configured to compute the similarity.

16. The apparatus according to claim 10, wherein the coding control scheme includes a scheme of controlling a cost function for the coding mode decision based on a magnitude of an activity of the input image, and the analysis unit is configured to compute the activity.

17. The apparatus according to claim 10, wherein the coding control scheme is to control a cost function for the motion vector detection based on a magnitude of an activity in the input image, and the analysis unit is configured to compute the activity.

18. The apparatus according to claim 10, wherein the coding control scheme includes a scheme of selecting a motion detection algorithm based on a magnitude of an interframe difference of the input image, and the analysis unit is configured to compute the interframe difference.

19. A computer readable storage medium storing instructions of a computer program which when executed by a computer results in performance of steps comprising:
setting an input parameter indicating a coding control scheme and a color conversion scheme, the coding control scheme including at least one of an adaptive quantization scheme, a coding mode decision scheme and a motion detection scheme, and the color conversion scheme corresponding to a level of a coding parameter changing in accordance with the coding control scheme;
analyzing an input image in accordance with the coding control scheme to compute the coding parameter;
processing the input image by color conversion in accordance with the color conversion scheme and the coding parameter to generate a processed image;
selecting one of a preview mode and a non-preview mode in accordance with a user instruction; and
coding the input image in a non-preview mode and coding the processed image in a preview mode in accordance with the coding control scheme of the input parameter and the coding parameter.
